(19) United States
(12) Patent Application Publication
(10) Pub. No.: US 2011/0071792 A1
(43) Pub. Date: Mar. 24, 2011

(54) CREATING AND VIEWING MULTIMEDIA CONTENT FROM DATA OF AN INDIVIDUAL'S PERFORMANCE IN A PHYSICAL ACTIVITY

(76) Inventor: Cameron Miner, Brentwood, NH (US)

(21) Appl. No.: 12/869,096

(22) Filed: Aug. 26, 2010

Related U.S. Application Data
(60) Provisional application No. 61/275,219, filed on Aug. 26, 2009.

(51) Int. Cl. G06F 19/00; G06K 9/00

(52) U.S. Cl. 702/182; 382/103

(57) ABSTRACT

Individuals participating in various sports or other physical activities can have data and media captured to provide a record of such activities. Small devices including a variety of sensors attached to individuals or equipment can capture data about the individual's performance. Video cameras, still image cameras and microphones can be placed throughout the venue or on the individuals to capture audio and image data. Audio, video, location information and performance data can be captured and then used to produce media of the activity. As a result of such data capture techniques, the data from sensors and the image and video data from the cameras are associated with the identification and location of the individual during the course of the individual's performance. Using this information, various media, such as videos, maps and other images, and combinations thereof, can be generated for each individual based on events occurring in the individual's performance and the location of the individual. Individuals can use such media for a variety of purposes, including but not limited to, sharing it with others.

### CROSS REFERENCE TO RELATED APPLICATIONS

This application is a nonprovisional application that claims, under 35 U.S.C. §119, priority to, and the benefit of, provisional patent application 61/275,219, filed Aug. 26, 2009, which is hereby incorporated by reference.

### BACKGROUND

When people participate in competitive or recreational sports or similar physical activities, it is common for them to want to evaluate their performance and share stories about their experiences with others. Participants might talk among their peers, friends and family after an event. They may capture the event with photographs or on video. While broadcast television provides substantial coverage of professional sporting events, the staffing, equipment and time required for such coverage is beyond the reach of the average person for their recreational activities.

### SUMMARY

Individuals participating in various sports or other physical activities can have data and media captured to provide a record of such activities. Small devices including a variety of sensors attached to individuals or equipment can capture data about the individual's performance. Video cameras, still image cameras and microphones can be placed throughout the venue, or on an individual, to capture audio and image data.

Audio, video, location information and performance data can be captured and then used to produce media of the activity. As a result of such data capture techniques, the data from sensors and the image and video data from the cameras are associated with the identification and location of the individual during the course of the individual's performance.

Using this information, various media, such as videos, maps and other images, and combinations thereof, can be generated for each individual based on events occurring in the individual's performance and the location of the individual. Individuals and venues can use such media for a variety of purposes. For example, individual can share media with others. Venues can display such media in common areas, for example.

### DESCRIPTION OF DRAWINGS

FIGS. 1 and 2 are schematic diagrams illustrating an individual performing an activity.

FIG. 3 is a data flow diagram describing an example of how video data can be selected.

FIG. 4 is a data flow diagram describing another example of how video data can be selected.

FIG. 5 is a data flow diagram describing an example of how a map of a performance can be created.

FIG. 6 is a data flow diagram describing an example of how media created for an individual can be displayed.

FIG. 7 is a diagram of a display used in a recreational sport.

FIG. 8 is a diagram of a display used for a competitive sport.

FIG. 9 is a diagram of a system that generates displays and advertisements.

### DETAILED DESCRIPTION

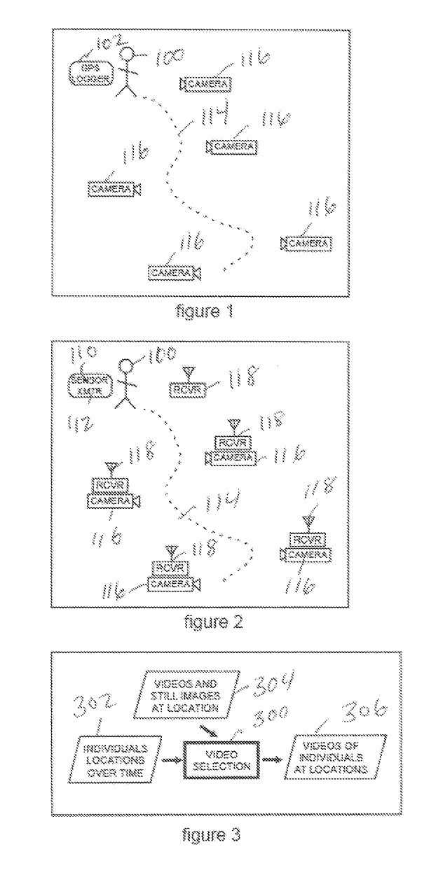

FIG. 1 is diagram illustrating an example system that gathers information and media associated with an individual's participation in a sport or other physical activity. An individual 100 is equipped with a GPS logger 102 (such as those available from Garmin, Apple's iPhone, etc.). During the course of the activity, the individual traverses a path over time, such that the user is in different locations over time, as indicated at 114. For example, path may be a run on a ski or snowboarding slope, a path of a bicycle race, a route taken by a runner or hiker, a run taken while surfing or waterskiing, a route taken by a water craft, such as a kayak, raft, canoe, motor boat or sail boat, a walk taken during a golf tournament, or any other physical activity. In FIG. 1, along the path 114, various video or still image capture devices 116 are placed. The cameras can be stationary in the environment (terrain park, big drop, bumps run, etc) or mobile (POV, handheld camera, phone) or fixed on a mobile platform (water ski boat, motorcycle, follow vehicle). Recording from the capture device is described in more detail below.

FIG. 2 is diagram illustrating another example system that gathers information and media associated with an individual's participation in a sport or other physical activity. In FIG. 2 an individual 100 is equipped with a sensor 110 and a transmitter 112. The sensor and transmitter may be separate devices or integrated devices. The sensor or transmitter may be attached to the individual's clothing or equipment or both. In this system, the individual also traverses a path 114 over time.

In FIG. 2, along the path 114, various video or still image capture devices 116 and receivers 118 are placed. A capture device 116 may include a receiver 118. A receiver also may be standalone device. The receiver is designed to communicate with the transmitter 112 to at least receive a signal from the transmitter 112. The receiver may be equipped with a GPS device that it accesses occasionally to retrieve its location. The receiver stores the data it receives, along with a time and date stamp indicating when the data was received, in a log file. The receiver may store this log file in local storage and periodically transmit it to remote storage, or can transmit the data to remote storage for storage in a log file. Storage may include local computer readable and writable storage or remote computer readable and writable storage (not shown) accessible through a computer network (not shown). The remote storage can be a central server for use by all receivers in a system. In this case, each receiver picks up an identifier from a transmitter, and stores the identifiers it has received along with the times they were received. With multiple receivers at known locations, this log can be used to create a map of the individuals' locations over time.

The transmitter can send any of a variety of signals to the receiver. For example, the transmitter can transmit a unique identifier (which would be associated with the individual wearing it). Such a device can be built using a transmitter, power source (battery or parasitic power harvesting like solar, heat, vibration), and circuitry which stores and transmits a unique serial number. In this example, the receiver 118 picks up the identifier from the transmitter, which is associated with an individual. The receiver time stamps and stores this information by creating a log file indicating the times different users passed by the receiver, such as:
TIMEDATESTAMP LOCATION (LAT, LON)
TIMEDATESTAMP USERID (X)
TIMEDATESTAMP USERID (Y)
TIMEDATESTAMP USERID (Z)

As another example, the transmitter 112 can transmit data from its associated sensors 110 to the receiver. The sensors can include a variety of devices such as global position system (GPS) location detectors, accelerometers, capacitive sensors, infrared sensors, magnetometers, gyroscopes and other sensors. In addition to a transmitter and power source, this device would include one or more sensors and a memory device. In this example the transmitter stores time stamped sensor data, such as GPS and accelerometer data, which also can include time stamped event data obtained from processing the sensor data. For example, in skiing and snowboarding, one can detect jumps, tricks and wipeouts from the accelerometer data and store time stamped data indicating when these events occurred. Thus the transmitting device has its own log file which is transmitted to the receiver. An example of a log file for this transmitter is shown below.
USERID (1234567890123456)
TIMEDATESTAMP LOCATION (LAT, LON)
TIMEDATESTAMP JUMP (HANGTIME)
TIMEDATESTAMP TRICK (HANGTIME, ROT_X, ROT_Y, ROT_Z)
TIMEDATESTAMP WIPEOUT (MAX_G_FORCE, TIME)

In this example, the receiver receives the data that is transmitted from an individual's sensor. For example, the sensors are capturing information (location, acceleration, rotation heading, etc.) during a run. When an individual comes into proximity of a receiver, this data can be transferred (downloaded) to a computer network. When the receiver receives data from such a transmitter, it creates a log file such as:
TIMEDATESTAMP LOCATION (LAT, LON)
TIMEDATESTAMP USERID (X); USERDATA (X)
TIMEDATESTAMP USERID (Y); USERDATA (Y)
TIMEDATESTAMP USERID (Z); USERDATA (Z)

Note that the user data includes time stamped data indicating the time the data was captured on the user's sensor. The time stamp in the receiver is the time the user data is received from the transmitter (when the individual was in proximity to the receiver).

In addition to storing data from the receivers, the system also records image data (e.g., video or still images) from the capture devices. For example, the video from a video capture device 116 is stored, for example in a video data file. The video data files may be time stamped. Using the known frame rate of the video, points in time in the video around a time stamp can be located. The data from the receiver associated with video capture device may be stored in association with the video data file, such as in a database with a link to the video data file or as metadata in the video data file. The video data files from multiple cameras in a system also can be stored on a central server (not shown).

As a result of such data capture techniques, the data from the sensors and the image and video data from the cameras are associated with the identification and location of the individual during the course of the individual's performance.

Using this information, various media, such as videos, maps and other images, and combinations thereof, can be generated for each individual based on events occurring in the individual's performance and the location of the individual. The downloaded information can be stored for access later or used for a variety of displays. Such displays include but are not limited to LCD/plasma/projection displays in public spaces, local and broadcast television coverage, internet sites, handheld devices.

As an example, referring now to FIG. 3, the creation of video of an individual's performance will now be described. A video selection module 300 receives data 302 indicative of an individual, and one or more locations of the individual at one or more points in time. Image data (such as video or still images) 304 is received, for which the location and time at which the image data was captured is known. The received data 302 may include, for example, a stream of location and time data for a known user. As another example, the received data 302 may be metadata, associated with video, which provides time information indicating when a known user was proximate a known location. The video selection module 300 identifies portions 306 of the video data 304 that correspond to the same individual, time and location as the input data 302. For example, module 300 searches the receiver logs associated with a camera for the individual's user identifier (USERID) to find the time the individual was near the camera. That time stamp is used to search for the video data file from that camera from around that point in time. With the example of FIG. 1, to select video clips from when the individual passed in front of each camera, the GPS log is searched to find time periods when the individual was near the camera. As another example, the user data from the transmitter can be searched to identify which cameras are located along the rider's path. Video clips from those cameras are selected based on the time that the rider is in the proximity each camera. Video from any camera can be selected and utilized as long as there is a valid time-date stamp on the video files to indicating what was happening while the individual was at a particular location or when a particular event occurred.

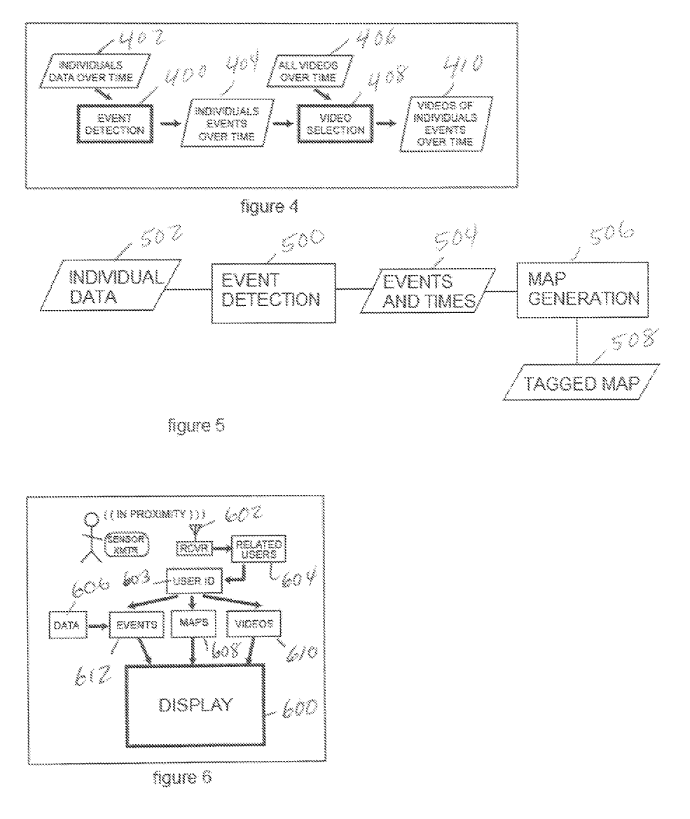

Similarly, as another example, referring now to FIG. 4, the creation of video can also be based on events occurring during the individual's performance. The presence of the individual in proximity to a receiver and video camera described above is one case of an event. In FIG. 4, an event is detected by an event detection module 400, which receives input data 402 related to the individual. This data can be any data associated with the individual over time during the course of the individual's performance, such as the data from the individual's sensors. There can be multiple event detection modules 400, for different kinds of events. The event detection module can reside on a device on the individual and process data in real time from the sensors, or can reside on a computer that processes data from various log files stored on the central server. A few examples of events include but are not limited to jumps, tricks, and wipeouts.

A jump can be defined as leaving the ground for a certain period of time, with some minimum threshold to minimize detection of very small, insignificant jumps. Leaving the ground can be detected in a variety of ways with a variety of sensors. For example, an accelerometer can sense when the individual leaves the ground by sensing a period of low G or zero G, and by sensing the higher G impact upon landing. Capacitive and IR sensors also can be used. Capacitive and IR sensors can be embedded into equipments such as skis, boards, shoes that are in contact with the ground but can sense when they leave the ground through either a change in capacitance or a change in the amount of light received. Data from such sensors can be processed to detect a jump, and a time stamp associated with that event.

A trick can be defined as a jump that includes rotation of a certain amount (180, 360, 540, 720, 900, 1080, etc) or even the same amount of rotation without leaving the ground (e.g., riding “switch” on snow, doing tricks on the surface of the water, etc.). The amount of rotation can be measured using a magnetometer or electronic gyroscope. Data from such sensors can be process to detect a trick and a time stamp associated with that event.

A wipeout can be defined a series of oscillations of high acceleration and random rotations. Wipeouts can further be categorized by the intensity of the accelerations or rotations and whether the individual continued to move after the wipeout (recovery).

The output of the event detector is data 404 indicating when an event has occurred over time. Similar to the data 302 in FIG. 3, the information about an individual, and when events related to that individual have occurred over time, can be used to select image data 406. The video selection module 408 identifies portions 410 of the video data 406 that corresponds to the same individual, time and events as the input data 404. The module may identify multiple segments of video data from different cameras (either cameras that are stationary or cameras that are worn or carried by the individual) at different locations at different times and events for an individual. For example, it is possible to use video from any camera (POV, camcorder, phone, etc. whether handheld or mounted on a boat, bike, etc.) to select clips based on an individual's events.

Given multiple segments of video data from different times and locations for an individual, these may be combined. For example, multiple video clips from an individual's run on a ski slope can be combined in time stamp order, and the result will be a video of the individual's run. In other words, as an individual moves through an environment that contains cameras, video and still images from various cameras can be selected based on when the individual is in proximity of the cameras. This combination of clips could be associated with a sound track, distributed to the individual, played back or shared online. Multiple images from a clip can be combined (for example, using P-frames data from an MPEG-4 stream) into one picture that shows the motion of the individual over time.

In another embodiment, shown in FIG. 5, using the individual's data over time 502, an event detector 500 provides an output that includes both time and location information 504 for the event relating to an individual's performance. In this embodiment, a map generation module 506 uses this information to output a map 508, with tags on locations on the map with data indicating that an event occurred at that location at a particular time. Multiple locations may be tagged with multiple events. This information can be stored in data files using the keyhole markup language (KML). Video associated with these events also may be identified and associated with a tagged location. Statistics about the activity, such as data about an event, the individual's speed, g-forces, jumps (height), trick (rotations), turn, and other performance data that can be derived from the sensors or other data also can be linked to the tagged location.

If a start location for the activity is known, the data can also be segmented into “runs” by detecting each time the individual is proximate the start location and treating the data between each occurrence of the start location as a separate run.

There are several ways in which the video, maps or other content created in this manner could be accessed and displayed to users. The content may be shared on social networking sites or other kinds of personal web sites, for example.

In one embodiment, such as shown in FIG. 6, a display 600 may be located in a public location, and a receiver 602 detects the presence of an individual. An identifier 603 for that individual (or related individuals as indicated at 604), are used to access content related to that user. The identification of the user enables data 606 and content to be gathered about that user to create media that can be displayed on the display 600. For example, a generated map 608, or selected video 610 or other information such as statistics about events 612 could be placed on display 600. Example suitable displays for such environments include but are not limited to a large LCD, plasma, or projector screen. Information and videos and maps also can be provided to a user through website access.

The kind of content that can be displayed on display 600 depends on the activity being performed and the location of the display. For example, for skiing or snowboarding, the display may be placed on a chair lift, gondola, lodge or other location. Example displays are, but are not limited to: a map of an individual's last run, the last known location of a relative or friend, a set of recent video clips including the individual, statistics and related to the last run.

The kind of content that can be displayed also may depend on the environment and audience, and the nature of the activity. For example, for recreational sports, one might be interested in sharing information among friends and family. When two or more riders choose to register in a way that recognizes a relationship (such as “friends”) they can see videos and maps based on each others' information. This would allow one user to see the last recorded location of another user that is a “friend.” In this instance the display with a receiver detects who is nearby and displays content relevant to that individual (maps, statistics, videos, a “friend finder” map) or just highlights of other riders that may have been in the same locations as the rider.

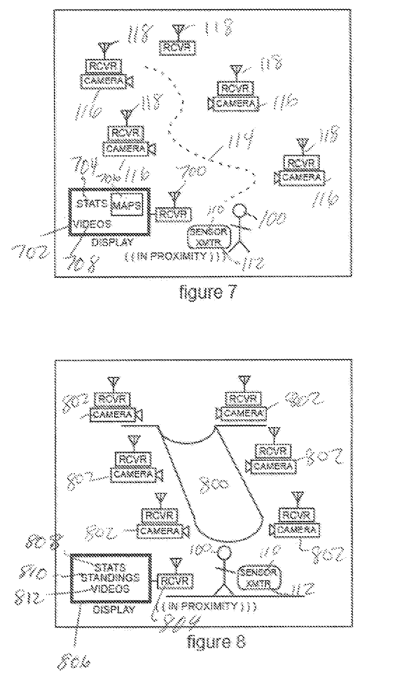

For example, as shown in FIG. 7, a ski area can be configured to capture video by placing cameras along the various trails. In FIG. 7, such a configuration is illustrated using the transmitter and receiver example described in connection with FIG. 2. A receiver 700 is located, for example, at the lodge, ski lift or other central location at the ski area. When the individual 100 is proximate receiver 700 (determined by the receiver sensing the transmitter 112), the display 702 can be updated with statistics 704, maps 706 and videos 708 relevant to that individual. In particular, the individual associated with the sensed transmitter is identified. The system then retrieves media data associated with the individual using an indication of the identified individual. The retrieved media data associated with the individual is displayed on the display while the individual is proximate the receiver.

As another example, in competitive sports, live information might be shared with an audience, whether at the venue or through broadcast television or the internet. For competitions, an individual's statistics (data from sensors and events derived from them) can be obtained immediately after run or even during the performance. The data that can be downloaded includes GPS coordinates, acceleration, rotation and details of events like jumps, tricks and wipeouts. The data can be combined with a graphics package and fed to the scoring system and sent out for TV broadcast, webcast, and displays at the competition venue. This data would enable viewers to quickly see information about the individual, and track standings across a variety of metrics such as highest speed, biggest jump, best trick, hardest wipeout (maximum G force), etc.

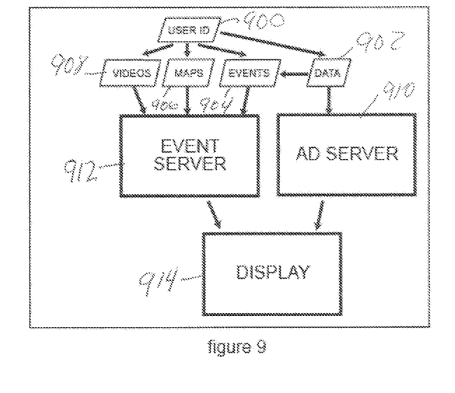

For example, as shown in FIG. 8, a snowboarding area 800 can be configured to capture video by placing cameras 802 along the trail used in a competition. In FIG. 8, such a configuration is illustrated using the transmitter and receiver example described in connection with FIG. 2. A receiver 804 is located, for example, at the bottom of the run. When the individual is proximate receiver 804 (determined by the receiver sensing the transmitter), the display 806 can be updated with statistics, standings and videos relevant to the individual that has just completed a run in the competition. The system identifies the individual associated with the sensed transmitter and retrieves the location and performance data associated with the individual using an indication of the identified individual. The retrieved location and performance data is processed to generate performance statistics. In this way, the performance of the participants can be evaluated.

Such a display can be a platform for advertisements. Advertisements could be selected based on the activity, location, sporting event, information about the individual, etc., and placed on the display along with the maps, videos or other statistics related to the individual. As shown in FIG. 9, given an identified individual 900, various data 902 can be retrieved (similar to FIG. 6). In this instance, in addition to the performance data used to retrieve the events 904, maps 906 and video 908 to generate a display, other data (such as a user profile) can be retrieved. The user profile is provided in systems in which an individual signs up for access to the computer system, and may have a username and password for log in purposes. The individual provides information about themselves and the activity or activities in which they are engaging, and the venues for these activities. A history of the individual's activities, and related media, can be stored and accessed. This information can be used by an ad server 910 to select an advertisement to be placed on the display 914 along with the other media, maps and statistics generated by an event server 912 for the individual.

The techniques described above can be implemented in digital electronic circuitry, or in computer hardware, firmware, software executing on a computer, or in combinations of them. The techniques can be implemented as a computer program product, i.e., a computer program tangibly embodied in tangible, machine-readable storage medium, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions described herein by operating on input data and generating output. Method steps can also be performed by, and apparatus of the invention can be implemented as, special purpose logic circuitry, e.g., an FPGA (field programmable gate array) or an ASIC (application-specific integrated circuit). Applications can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Storage media suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

A computing system can include clients and servers. A client and server are generally remote from each other and typically interact over a communication network. The relationship of client and server arises by virtue of computer programs running on the respective computers and having a client-server relationship to each other.

Having described an example embodiment, it should be apparent to those skilled in the art that the foregoing is merely illustrative and not limiting, having been presented by way of example only. Numerous modifications and other embodiments are with the scope of ordinary skill in the art and are contemplated as falling with the scope of the invention.

What is claimed is:

1. A method for selecting image data for a program relating to an individual's participation in a physical activity, comprising:
receiving data indicative of positions of an individual over time;
accessing image data captured of a location over time; and
selecting portions the image data according to an intersection of the positions of the individual over time and the location.

2. The method of claim 1, wherein the positions of the individual over time includes data of a detector detecting the presence of the individual in the proximity of the location.

3. The method of claim 1, wherein the positions of the individual over time includes data from a transmitter indicating the position of the individual at each of a plurality of points in time.

4. A method for generating a map describing an individual's participation in a physical activity, comprising:
receiving data indicative of motion of an individual over time; and
generating a map according to events related to the motion of the individual over time.

5. A method for generating a media program related to an individual's participation in a physical activity, comprising:
receiving data indicative of motion of an individual over time;
accessing image data captured over time; and
selecting portions the image data according to events related to the motion of the individual over time.

6. The method of claim 5, wherein the data indicative of the motion of the individual over time comprises data indicative of the location of the individual over time; wherein the video data is captured of a location over time, and wherein the event related to the motion of the individual over time is the proximity of the individual to the location captured in the video data.

7. A method for evaluating a performance of an individual, comprising:
sensing whether a transmitter is proximate a receiver;
identifying an individual associated with the sensed transmitter;
retrieving location and performance data associated with the individual using an indication of the identified individual;
processing the retrieved location and performance data to generate performance statistics;
causing the performance statistics to be displayed.

8. A method for providing media data associated with an individual's performance,
sensing whether a transmitter is proximate a receiver;
identifying an individual associated with the sensed transmitter;
retrieving media data associated with the individual using an indication of the identified individual;
displaying the retrieved media data associated with the individual on a display while the individual is proximate the receiver.
